(19) United States
(12) Patent Application Publication
(10) Pub. No.: US 2018/0114987 A1
(43) Pub. Date: Apr. 26, 2018

(54) RECHARGEABLE ZINC ION BATTERY WITH GRAPHENE OXIDE AS POSITIVE ELECTRODE

(71) Applicant: SHENZHEN CUBIC-SCIENCE CO., LTD., Shenzhen, Guangdong (CN)

(72) Inventor: ChunGuang WEI, Shenzhen, Guangdong (CN)

(21) Appl. No.: 15/562,972

(22) PCT Filed: Mar. 31, 2015
(86) PCT No.: PCT/CN2015/075483

§ 371 Date: Sep. 29, 2017

(51) Int. Cl. H01M 4/583; H01M 10/36

(52) U.S. Cl. CPC H01M 4/583; H01M 2004/028; H01M 10/36

(57) ABSTRACT

The invention relates to a zinc ion battery with graphene oxide as a positive electrode. The rechargeable zinc ion battery is composed of a positive electrode, a negative electrode, an isolating membrane between the positive electrode and the negative electrode and an electrolyte, zinc element is mainly used as an active material of the negative electrode, an active material of the positive electrode is graphene oxide, the electrolyte is a liquid electrolyte with soluble salt of zinc and soluble salt of manganese as a solute and with water as a solvent and having ionic conductivity. The battery has characteristics of high capacity, low cost and repeated charge-discharge performance, and can be widely applied in the fields of mobile phones, personal digital notepads, cordless telephones, electronic toys, game machines, personal audio video units, portable data terminals, palmtop computers, experimental devices and the like.

### FIELD OF THE INVENTION

The patent belongs to technology of the battery field, and more particular, to a zinc ion battery with graphene oxide as a positive electrode.

### BACKGROUND OF THE INVENTION

Compared to a primary battery, a secondary battery can be repeatedly recycled, effectively reducing the waste of resources and environmental pollution.

Chinese Patent (CN 101540417A) invents a zinc ion battery, composing a rechargeable zinc ion battery with manganese dioxide (MnO₂) as a positive electrode, and zinc as a negative electrode, and water containing zinc ions as an electrolyte. Such rechargeable zinc ion battery is invented based upon two behaviors of Zn²⁺ ions: Zn²⁺ ions have rapid reversible embedding and separating behavior in a manganese dioxide material of large tunnels, on the other hand, Zn²⁺ ions can be rapidly reversibly dissolved and deposed in a neutral electrolyte (such as zinc sulfate or zinc nitrate) containing Zn²⁺ ions. The charge and discharge capacity of the rechargeable zinc ion battery is about 200 mAh per gram (mAh/g).

For any battery, the increase in electrode capacity has a significant impact on the battery performance. Due to the positive electrode of the zinc ion battery in the patent with graphene oxide instead of manganese dioxide, with aqueous solution containing manganese ions and zinc ions as the electrolyte, the battery performance has been greatly improved, and the charge and discharge capacity reaches 1200 mAh/g.

### SUMMARY OF THE INVENTION

Graphene oxide is an intermediate product of graphene prepared by an oxidation-reduction method, and also an oxide of graphene. It is the product obtained by oxidation of graphite raw material, its structure is to externally connect a large number of oxygen-containing functional groups based on the graphene: an upper surface and a lower surface of the graphene oxide are connected with a large number of hydroxyl and epoxy, and edges thereof are attached with a large number of carboxyl and carbonyl and other functional groups. Due to the introduction of a large number of oxygen-containing groups on the surface and the edge, graphene oxide is easy to modify and functionalize, and maintains the chemical stability. A high conjugated structure of graphene is damaged in the oxidation process to a certain extent, so that the graphene oxide has a larger specific surface area and layered structure.

Graphene needs to be prepared by expanding and reducing the graphene oxide in high temperature and vacuum, so the preparation process of the graphene oxide is simple compared to graphene, without the high temperature and vacuum conditions of graphene; therefore, equipment required for preparation is simple. Due to the use of the graphene oxide, the manufacturing technique of the material can be greatly simplified, the cost of the manufacturing equipment and the manufacturing cost of the material can be reduced; therefore, the use of the graphene oxide can greatly reduce the manufacturing cost of the battery while maintaining the high capacity of the battery.

A rechargeable zinc ion battery with graphene oxide as a positive electrode proposed by the invention is composed of a positive electrode, a negative electrode, an isolating membrane between the positive electrode and the negative electrode and an electrolyte, zinc element is mainly used as an active material of the negative electrode, an active material of the positive electrode is graphene oxide, the electrolyte is a liquid material with soluble salt of zinc and soluble salt of manganese as a solute and with water as a solvent and having ionic conductivity. The positive electrode comprises a current collector and a positive electrode membrane attached to the current collector, and the positive electrode membrane is made of the active material of the positive electrode, an electronic conductive agent and a binding agent. Among them, the electronic conductive agent may be made of graphite, carbon black, acetylene black, carbon fiber or carbon nanotube, etc., the additive amount is less than 50% of the mass of the positive membrane; the binding agent may be polytetrafluoroethylene, water-soluble rubber, PVDF or cellulose, etc., and the additive amount of the positive membrane is less than 20% of the mass of the positive membrane. The negative electrode may be made of zinc foil or zinc powder. The negative electrode may also use the following scheme: the negative electrode comprises a current collector and a negative electrode membrane attached to the current collector, the negative electrode membrane may be made of zinc powder and a binding agent, or may further be added with a corrosion inhibitor and/or an electronic conductive agent in the negative electrode membrane, wherein the additive amount of the electronic conductive agent is less than 50% of the mass of the negative electrode membrane, the additive amount of the corrosion inhibitor is equal to or less than the mass of the negative electrode membrane, and the additive amount of the binding agent is less than 50% of the mass of the negative electrode membrane.

The invention adopts a new system, utilizing the oxidation-reduction reaction of divalent manganese ions in the electrolyte to greatly improving the electrochemical performance of the battery. During the charging process of the battery, the divalent manganese ions in the electrolyte are oxidized to produce MnO₂ attached to the surface of the positive graphene oxide, the zinc ions are removed from the MnO₂ tunnel, and MnO₂ is formed from ZnMn₂O₄. During the discharge of the battery, the MnO₂ attached to the surface of the positive electrode is reduced to divalent manganese ions. The zinc ions in the electrolyte are embedded in the large tunnel of MnO₂ to form ZnMn₂O₄.

FIG. 1(a) is a picture of a transmission electron microscope of graphene oxide electrode slice while charging to 1.55V and it can be seen from FIG. 2, that a large number of MnO₂ is produced on the surface of the graphene oxide. FIG. 1 (b) is a picture of the transmission electron microscope of the graphene oxide electrode slice while discharging to 1.00V. At this time, no particles exist on the surface of the graphene oxide, indicating that the MnO₂ attached to the surface of the positive electrode during the discharging process is also reduced to divalent manganese ions.

Graphene needs to be prepared by expanding and reducing the graphene oxide in high temperature and vacuum, so the preparation process of the graphene oxide is simple compared to graphene, without the high temperature and vacuum conditions of graphene; therefore, equipment required for preparation is simple. Due to the use of the graphene oxide, the manufacturing technique of the material can be greatly simplified, the cost of the manufacturing equipment and the manufacturing cost of the material can be reduced; therefore, the use of the graphene oxide can greatly reduce the manufacturing cost of the battery while maintaining the high capacity of the battery.

The zinc ion battery with the graphene oxide as the positive electrode has the characteristics of high capacity, no pollution, low cost and good cycle performance, etc. Experiments show that the battery capacity in the invention can be as high as 1200 mAh/g or more. It can be expected that this zinc ion battery can be widely applied in the fields of personal digital notepads, electronic toys, cordless telephones, game machines, experimental devices, portable data terminals, palmtop computers, personal audio video units and the like.

### BRIEF DESCRIPTION OF THE DRAWINGS

FIG. 1: (a) zinc ion battery with graphene oxide as positive electrode is charged to 1.55V positive electrode membrane TEM; (b) zinc ion battery with graphene oxide as negative electrode is discharged to 1.00V negative electrode membrane TEM;

FIG. 2: CV curve of cell 1 at a rate of 0.1 mV/s;

FIG. 3: cycle life of cell 2 at an electric current density of 0.1 A/g;

FIG. 4: cell 2 provides charging and discharging curve at the electric current density of 0.1 A/g; and

FIG. 5: cycle life of cell 3 at an electric current density of 5 A/g.

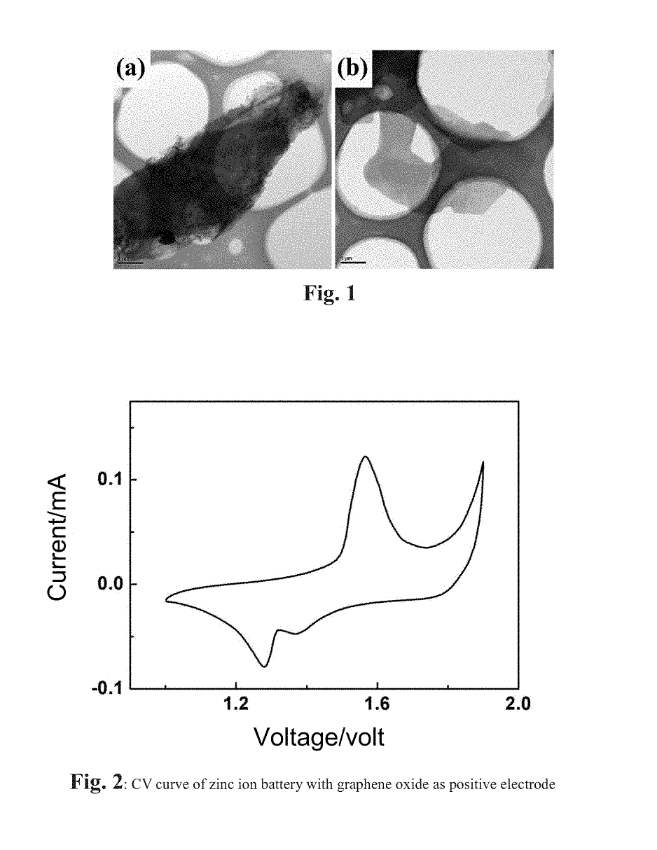

### DETAILED DESCRIPTION OF THE PREFERRED EMBODIMENTS

### Embodiment 1

Preparation of the positive electrode sheet: 50 mg of graphene oxide, 14.28 mg of conductive agent acetylene black and 7.14 mg of binding agent polytetrafluoroethylene were uniformly mixed and then coated on a stainless steel foil, dried in a vacuum oven at 80° C., and then punched to obtain the positive electrode sheet 1, the positive electrode sheet 2 and the positive electrode sheet 3 having a diameter of 1.5 cm.

Preparation of the negative electrode sheet: 0.35 g of zinc powder, conductive agent acetylene black, carbon nanotube and binding agent were uniformly mixed and coated on 0.1 mm-thick zinc foil, dried in a vacuum oven at 80° C., and then punched to obtain the negative electrode sheet 1, the negative electrode sheet 2 and the negative electrode sheet 3 having a diameter of 1.5 cm.

Preparation of electrolyte: an aqueous solution of 2 mol/L of ZnSO₄ and 1 mol/L of MnSO₄ was used as the electrolyte.

The battery as cell 1 was assembled by the positive electrode sheet 1, the negative electrode sheet 1 and the aqueous solution of 2 mol/L of ZnSO₄ and 1 mol/L of MnSO₄. Through test, the CV curve of the cell 1 at the rate of 0.1 mV/s is shown in FIG. 2.

From the CV curve of FIG. 2, it can be seen that there is a significant redox peak in the charging and discharging process. It is an oxidation peak at the voltage of 1.56V and 1.61V, which represents the divalent manganese ions in the electrolyte are oxidized into MnO₂ and zinc ions separated from a MnO₂ tunnel. It is a reduction peak at the voltage of 1.28V and 1.37V, which represents MnO₂ attached to the surface of the positive electrode is also reduced as the divalent manganese ions and the zinc ions embedded into the MnO₂ tunnel.

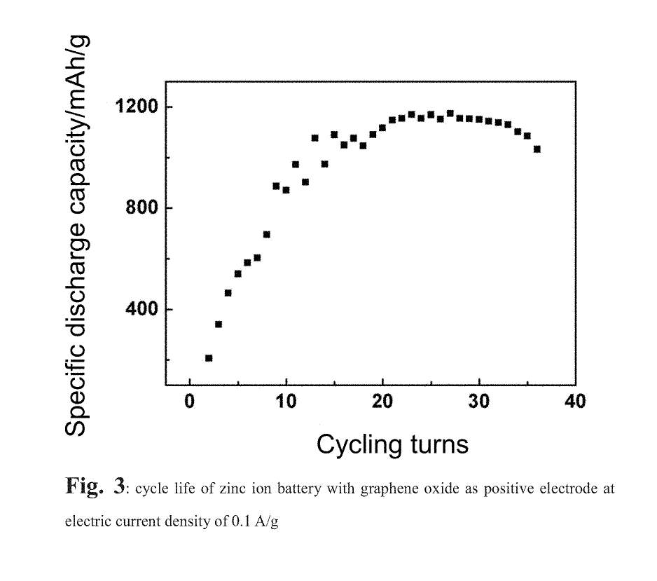

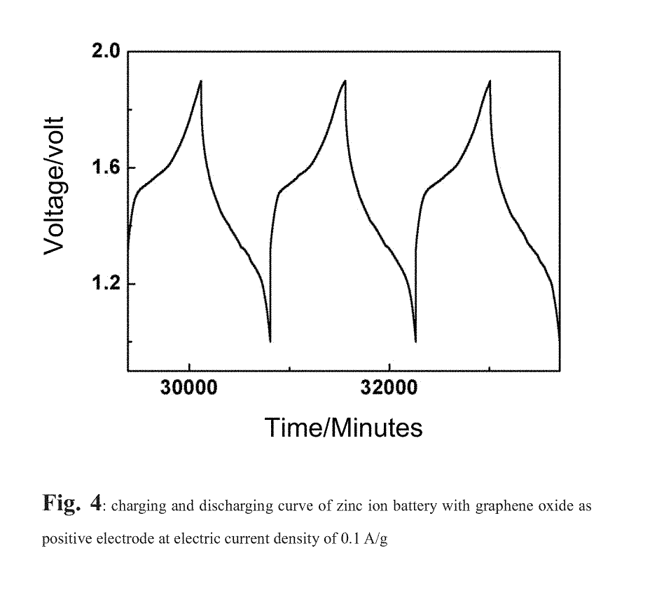

The battery as cell 2 was assembled by the positive electrode sheet 2, the negative electrode sheet 2 and the aqueous solution of 2 mol/L of ZnSO₄ and 1 mol/L of MnSO₄. Through test, the cycle life of the cell 2 at the electric current density of 0.1 A/g is shown in FIG. 3, and the charging and discharging curve at the electric current density of 0.1 A/g is shown in FIG. 4.

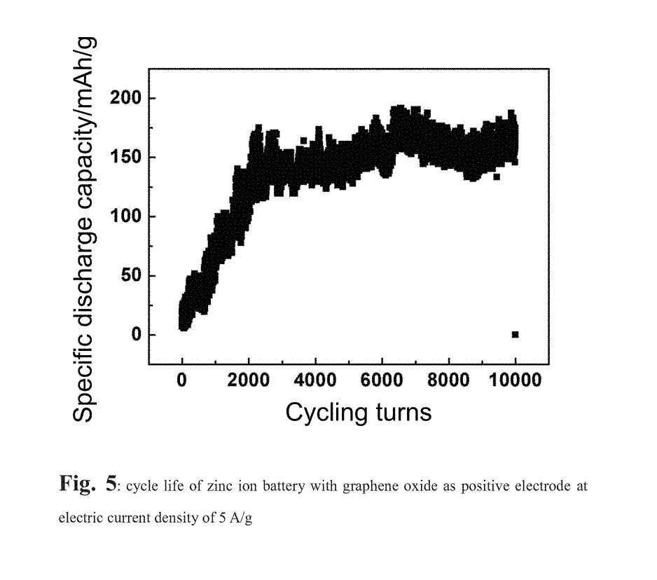

The battery as cell 3 was assembled by the positive electrode sheet 3, the negative electrode sheet 3 and the aqueous solution of 2 mol/L of ZnSO₄ and 1 mol/L of MnSO₄. Through test, the cycle life of the cell 3 at the electric current density of 5 A/g is shown in FIG. 5.

1. A zinc ion battery with graphene oxide as a positive electrode, composed of a positive electrode, a negative electrode, an isolating membrane between the positive electrode and the negative electrode and an electrolyte with ionic conductivity, wherein zinc element is mainly used as an active material of the negative electrode; an active material of the positive electrode is graphene oxide; the electrolyte is a liquid or gel state material with soluble salt of zinc and soluble salt of manganese as a solute and with water as a solvent and having ionic conductivity.

2. The zinc ion battery with graphene oxide as a positive electrode according to claim 1, wherein the positive electrode comprises a current collector and a positive electrode membrane attached to the current collector, and the positive electrode membrane is made of the active material of the positive electrode, an electronic conductive agent and a binding agent.

3. The zinc ion battery with graphene oxide as a positive electrode according to claim 1, wherein the negative electrode is made of pure metal zinc, alloy of zinc or zinc powder.

4. The zinc ion battery with graphene oxide as a positive electrode according to claim 1, wherein the negative electrode comprises a current collector and a negative electrode membrane attached to the current collector, and the negative electrode membrane is made of zinc powder and a binding agent.

5. The zinc ion battery with graphene oxide as a positive electrode according to claim 1, wherein the negative electrode comprises a current collector and a negative electrode membrane attached to the current collector, and the negative electrode membrane is made of zinc powder, a binding agent and a corrosion inhibitor.

6. The zinc ion battery with graphene oxide as a positive electrode according to claim 1, wherein the negative electrode comprises a current collector and a negative electrode membrane attached to the current collector, and the negative electrode membrane is made of zinc powder, a binding agent and an electronic conductive agent.

7. The zinc ion battery with graphene oxide as a positive electrode according to claim 1, wherein the negative electrode comprises a current collector and a negative electrode membrane attached to the current collector, the negative electrode membrane is made of zinc powder, a binding agent, a corrosion inhibitor and an electronic conductive agent, an additive amount of the electronic conductive agent is less than 50% of mass of the negative electrode membrane, and an additive amount of the corrosion inhibitor is less than 1% of mass of the negative electrode membrane.

8. The zinc ion battery with graphene oxide as a positive electrode according to claim 1, wherein the soluble salt of zinc is zinc nitrate, zinc sulfate or zinc chloride, the soluble salt of manganese is manganese nitrate, manganese sulfate or manganese chloride.

9. The zinc ion battery with graphene oxide as a positive electrode according to claim 2, wherein the soluble salt of zinc is zinc nitrate, zinc sulfate or zinc chloride, the soluble salt of manganese is manganese nitrate, manganese sulfate or manganese chloride.

10. The zinc ion battery with graphene oxide as a positive electrode according to claim 3, wherein the soluble salt of zinc is zinc nitrate, zinc sulfate or zinc chloride, the soluble salt of manganese is manganese nitrate, manganese sulfate or manganese chloride.

11. The zinc ion battery with graphene oxide as a positive electrode according to claim 4, wherein the soluble salt of zinc is zinc nitrate, zinc sulfate or zinc chloride, the soluble salt of manganese is manganese nitrate, manganese sulfate or manganese chloride.

12. The zinc ion battery with graphene oxide as a positive electrode according to claim 5, wherein the soluble salt of zinc is zinc nitrate, zinc sulfate or zinc chloride, the soluble salt of manganese is manganese nitrate, manganese sulfate or manganese chloride.

13. The zinc ion battery with graphene oxide as a positive electrode according to claim 6, wherein the soluble salt of zinc is zinc nitrate, zinc sulfate or zinc chloride, the soluble salt of manganese is manganese nitrate, manganese sulfate or manganese chloride.

14. The zinc ion battery with graphene oxide as a positive electrode according to claim 7, wherein the soluble salt of zinc is zinc nitrate, zinc sulfate or zinc chloride, the soluble salt of manganese is manganese nitrate, manganese sulfate or manganese chloride.
